(19) United States
(12) Patent Application Publication
(10) Pub. No.: US 2004/0103440 A1
(43) Pub. Date: May 27, 2004

(54) Transmitter in a digital return link for use in an HFC network

(75) Inventors: Niranjan Samant, Lansdale, PA (US); Arthur Paolella, Jamison, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation

(21) Appl. No.: 10/304,358

(22) Filed: Nov. 25, 2002

(51) Int. Cl. H04N 7/173

(52) U.S. Cl. 725/118; 725/121; 725/123

(57) ABSTRACT

A transmitter in a digital return link for use in an HFC network includes an analog to digital converter for digitizing a broadband analog RF input. The A/D converter has a parallel bit stream output. A serializer converts the parallel bit stream from the converter to a serial bit stream. An electroabsorption modulated laser converts the serial bit stream to an optical serial bit stream for transmission over the HFC network.

### BACKGROUND OF THE INVENTION

1. Field of the Invention

The present invention relates generally to a digital return link in a hybrid fiber cable (“HFC”) network and, more particularly, to increasing the efficiency of signal transmission through a digital return link in an HFC network.

2. Background Information

Digital return links in HFC networks are generally known in the art. For example, cable transmission systems which supply cable television (“CATV”) signals routinely employ a digital return path or link in the bidirectional HFC network so that the end user or subscriber application can be monitored and/or return information to the head end over the digital return link. Typically, the forward path (the path sending information to the end user) has a bandwidth allocation of approximately 700 MHz, and the return path (the path returning information to the head end) has a bandwidth allocation of approximately 35 MHz.

Until recently, the available bandwidth in HFC digital return paths has not been utilized effectively. Most applications utilizing a digital return link have been for monitoring the HFC network and/or running minimal services or instructions from the end user, and therefore did not require much bandwidth in the return path. However, HFC applications requiring additional bandwidth and better performance in the digital return link are on the rise. Such applications include CATV, IP telephony, cable modems, high speed Internet and VOD services. Because of the high costs associated with upgrading existing cable transmission plants to increase the available bandwidth, it is desirable to more effectively utilize the return path bandwidth in existing HFC transmission systems.

A major component of a digital return link is the digital return transmitter, which transmits information from the subscribers over the digital return link to the head end. Existing digital return transmitters employ directly modulated lasers (“DMLs”), modulated at the transmission bit rate. DMLs produce laser chirp, which has a dispersive effect on the optical signal transmitted over the digital return link. Although dispersion compensators are utilized with DMLs, the chirp-induced dispersion limits the maximum distance to which the optical signal can be usefully transmitted. Thus, present digital return transmitters limit the range of use of the return path. Using DMLs, the maximum viable signal distance achieved over conventional digital return links is approximately 230 km.

### BRIEF SUMMARY OF THE INVENTION

A transmitter in a digital return link for use in an HFC network includes an analog to digital converter for digitizing a broadband analog RF input. The converter has a parallel bit stream output. A serializer converts the parallel bit stream output from the converter into a serial bit stream. An electroabsorption modulated laser converts the serial bit stream into an optical serial bit stream for transmission over the HFC network.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a block diagram of a digital return link having a digital return transmitter according to a first embodiment of the present invention;

FIG. 2 is a block diagram of a digital return link having a digital return transmitter according to second embodiment of the present invention; and

FIG. 3 is a block diagram of an alternative embodiment of a digital return link having a digital return transmitter according to the embodiment of FIG. 2.

### DETAILED DESCRIPTION OF THE INVENTION

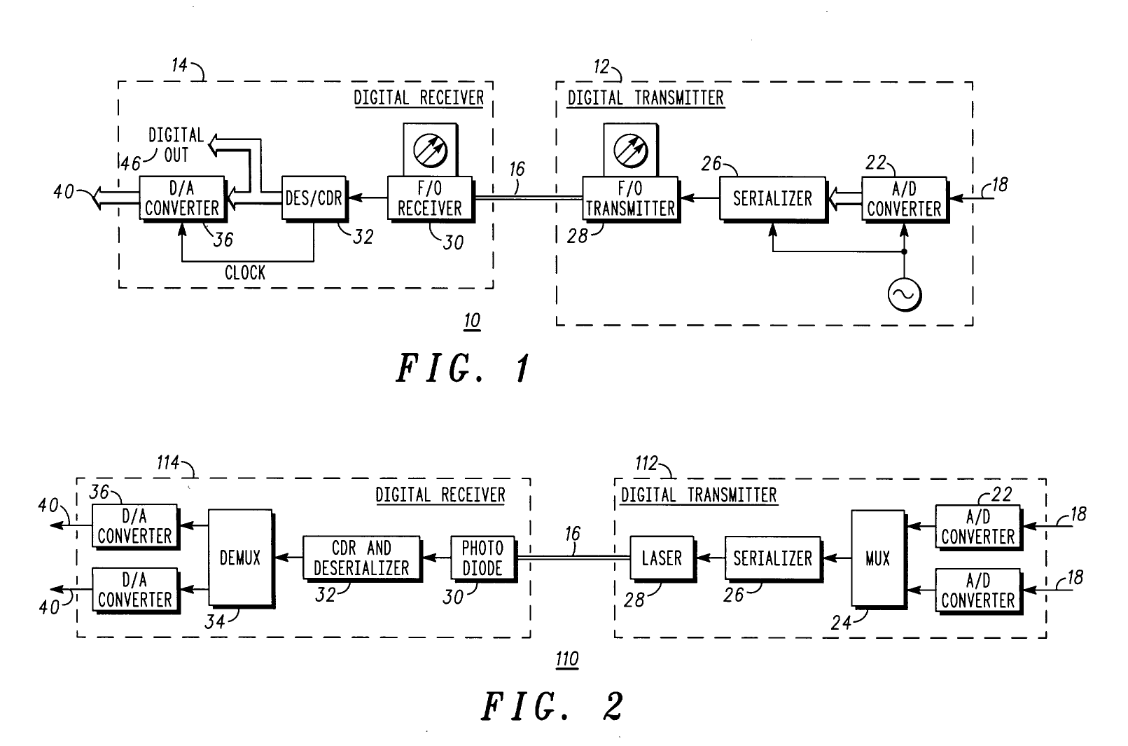

Referring to FIGS. 1-3, a digital return link 10 includes a digital transmitter 12 according to the present invention. The digital return link 10 is part of an HFC network, for example, a CATV transmission system. The digital transmitter 12 is preferably located in a fiber optic node or hub (not shown). The fiber optic node connects to the end users or subscribers in the HFC network. Information from the subscribers is input to the fiber optic node for transmission to the head end. The digital return link 10 also includes a digital receiver 14 which connects to the head end of the HFC network. An optic fiber cable 16 connects the digital transmitter 12 and the digital receiver 14, and thus completes the digital return link 10 from the fiber optic node to the head end.

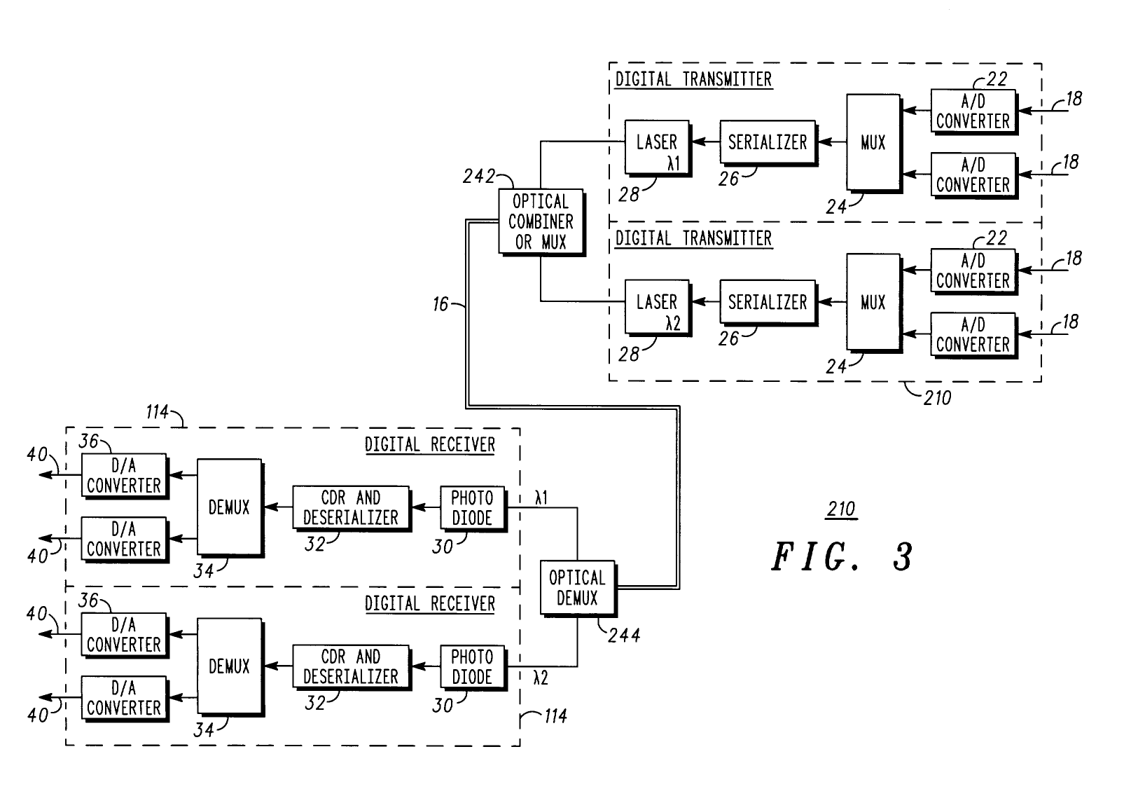

The digital transmitter 12 includes one or more analog inputs 18 for inputting a signal to the digital transmitter 12. The signal input via the analog inputs 18 is preferably a broadband RF signal, generally in the range of 5 to 42 MHz or 5 to 65 MHz. As shown in the preferred embodiment of FIG. 1, the digital transmitter 12 has one analog input 18. However, as will become evident from the following discussion, the number of analog inputs 18 to the digital transmitter 12 may vary depending on the application and capabilities of the digital transmitter 12. For example, as shown in the embodiment of FIG. 2, the digital transmitter 112 includes two analog inputs 18. The embodiment of FIG. 3 includes a pair of digital transmitters 112, each with two analog inputs 18, for a total of four analog inputs 18.

The digital transmitter 12 includes an analog to digital (“A/D”) converter 22 corresponding to each analog input 18. The A/D converter 22 converts the analog signal received from the analog input 18 into a digital signal in the form of a parallel bit stream.

The digital transmitter 12 includes a serializer 26 which converts the parallel bit stream output from the A/D converter 22 into a serial bit stream. The serial bit stream from the serializer 26 is input to an electroabsorption modulated laser (“EML”) 28. An EML is externally modulated, such that the laser is operated in a continuous wave mode and the light output of the laser is passed through a medium that modulates the light at the transmission bit rate for transmission through fiber. The EML 28 converts the serial bit stream from the serializer 26 into an optical serial bit stream for transmission over the optical fiber cable 16 to the digital receiver 14 at the head end of the HFC network. The EML 28 is modulated by the serial bit stream at approximately 2.5 gigabits per second, such that the data is transmitted over the HFC network at this rate. The EML 28 may be modulated at other rates by the serial bit stream input to the EML 28, depending on the desired application. Therefore the transmission rate over the digital return link 10 will vary accordingly.

Still referring to FIG. 1, the digital receiver 14 receives the optical serial bit stream from the EML 28 at the photo diode 30. The photo diode 30 converts the optical serial bit stream into an electrical serial bit stream. The electrical serial bit stream from the photo diode 30 is input to a deserializer and a clock and data recovery (“CDR”) circuit 32. The deserializer 32 converts the electrical serial bit stream into a parallel bit stream. The parallel bit stream from the deserializer 32 is input to a digital to analog converter (“D/A”) 36, which converts the signal transmitted to the digital receiver 14 into the original analog data input to the analog input 18. The signal from the D/A converter 36 is output via the one or more analog outputs 40 in the corresponding 5 to 42 MHz or 5 to 65 MHz band for further transmission into the head end of the HFC network. Alternatively, as shown in FIG. 1, the digital receiver 14 may output the digital parallel bit stream directly from the deserializer 32 at the digital output 46, depending on the desired application of the data.

When using the EML 28 (as opposed to a DML), the transmitter 12 is capable of transmitting the optical serial bit stream over the optic fiber cable 16 to distances up to and above 400 km using non-dispersion shifted fiber at 2.5 gigabits. This EML transmission distance exceeds conventional DML transmission distances by approximately 200 km. Experimentation indicates that EMLs may be able to reach up to 600 km in a digital return link.

Since EMLs use external modulation integrated with a laser on a single chip, laser chirp is significantly reduced. Thus, using the EML 28 in the digital transmitter 12 eliminates chirp-induced dispersion (which prevents DMLs from effectively transmitting to distances over 200 km) of the optical serial bit stream, and eliminates the need for dispersion compensators in the digital return link 10. Although it is theoretically possible to use a DML in the digital transmitter 12 to achieve return path distances greater than the conventional 200 km currently obtained with DMLs, to actually achieve such a long return path distance using a DML would require replacement of the optical fiber cable 16 with special fiber cable throughout the HFC network and/or special optical amplifiers with dispersion compensators to compensate for the large amount of chirp-induced dispersion which would result from using a DML to transmit such a long distance. Both of these alternatives are significantly more expensive than using an EML 28. Although an EML itself is more expensive than a DML, the cost of the additional equipment required to use a DML to achieve longer return path distances is cost prohibitive. Similarly, it is also possible to use a Mach-Zehnder type external modulator in the digital transmitter 12 instead of the EML 28. However, implementing a Mach-Zehnder modulator would also be cost prohibitive since the modulator itself is significantly more expensive than either a DML or EML.

Referring to FIGS. 2 and 3, two alternative embodiments of the present invention are shown. In the digital return link 110 of FIG. 2, the digital transmitter 112 includes two analog inputs 18, with an A/D converter 22 for each respective analog input 18. Since there are thus two different analog signals input to the digital transmitter 112, and only one transmission point (i.e., the EML 28), the digital transmitter 112 includes a multiplexer 24. The parallel bit stream from each A/D converter 22 is input to the multiplexer 24 which selects only one of the parallel bit stream outputs from the A/D converters 22 at any given time. The multiplexer 24 thus switches back and forth between the parallel bit stream outputs from the respective A/D converters 22, and sends the appropriate parallel bit stream to the serializer 26 for modulation of the EML 28. In the embodiment of FIG. 1 which has only one analog input 18, a multiplexer 24 is not necessary since there is only ever one parallel bit stream from only one A/D converter 22 to be input to the serializer 26. The digital receiver 114 operates in substantially the same manner as the digital receiver 14 described with respect to FIG. 1. However, the digital receiver 114 includes a demultiplexer 34 for separating the parallel bit stream from the deserializer 32 into two individual parallel bit streams respective to their analog inputs 18.

Additionally, as shown in FIG. 3, the EML 28 is employed in a digital return link 210 such that there are two digital transmitters 112, each with one EML 28. The digital return link 210 of FIG. 3 uses two digital transmitters 112, each with two analog inputs 18, for a total of four analog inputs 18, thereby further increasing the use of the available digital return path bandwidth. The outputs of the EML 28 for each transmitter 112 feed to an optical combiner 242 which multiplexes the two optical serial bit streams over the same optical fiber cable. An optical demultiplexer 244 before the digital receivers 114 separates the incoming optical serial bit stream into its respective signals for decoding by each digital receiver 114. Numerous other embodiments of a digital return link utilizing an EML are feasible.

In the embodiments shown in FIGS. 1-3, the EML 28 is preferably mounted on a board having the same size as that used for a DML used with the digital transmitter 12. Thus, integrating the EML 28 into existing digital return transmitters does not require any additional cost to reconfigure the remaining portions of the transmitter itself. The only significant changes necessary to existing transmitters are the bias and impedance matching circuitry alterations to reflect the EML 28, as opposed to a DML. Furthermore, the EML 28 in the digital transmitter 12 does not affect the application type; the EML 28 can be used with a variety of HFC network applications other than CATV transmission systems to increase return path transmission distance in those applications.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A transmitter in a digital return link for use in an HFC network comprising:
(a) an analog to digital converter for digitizing a broadband analog RF input, the converter having a parallel bit stream output;
(b) a serializer which converts the parallel bit stream from the converter to a serial bit stream; and
(c) an electroabsorption modulated laser which converts the serial bit stream to an optical serial bit stream for transmission over the HFC network.

2. The transmitter of claim 1, wherein the HFC network is a CATV network.

3. The transmitter according to claim 1, wherein the RF input is information to be sent upstream to the head end of the HFC network.

4. The transmitter of claim 1, wherein the frequency of transmission is at least about 2.5 gigabits per second.

5. A method of transmitting in a digital return link in an HFC network, the method comprising:
digitizing a broadband analog RF input using an analog to digital converter, the converter having a parallel bit stream output;
converting the parallel bit stream from the converter to a serial bit stream using a serializer; and
converting the serial bit stream to an optical serial bit stream using an electroabsorption modulated laser for transmission over the HFC network.
